(19) United States
(12) Patent Application Publication
(10) Pub. No.: US 2014/0112489 A1
(43) Pub. Date: Apr. 24, 2014

(54) SIGNAL CANCELLATION

(71) Applicant: LECTRONIX, INC., Lansing, MI (US)

(72) Inventor: Earl Goodrich, II, East Lansing, MI (US)

(73) Assignee: LECTRONIX, INC., Lansing, MI (US)

(21) Appl. No.: 13/657,987

(22) Filed: Oct. 23, 2012

(51) Int. Cl. G10K 11/16

(52) U.S. Cl. CPC G10K 11/16
USPC 381/71.1

(57) ABSTRACT

Signal cancellation is contemplated. The signal cancellation may include canceling a signal from another signal in order to facilitate further processing of the another signal. The signal cancellation may be beneficial within environments where the signal being canceled is intentionally introduced or its contents/characteristics are otherwise known prior to being exposed to the signal from which it is to be canceled.

### TECHNICAL FIELD

The present invention relates to signal cancellation, including facilitating cancellation of intentionally introduced signaling from a sampling taken within an environment exposed to the intentionally introduced background signaling, such as but not necessarily limited to canceling siren signaling from a sampling taken with a microphone exposed to the intentionally introduced background signaling.

### BACKGROUND

Signal cancellation relates to removing, manipulating, or otherwise ameliorating influences of an undesirable signal relative to another signal, such as but not necessarily limited to removing noise or other background signaling from a sampling taken by a microphone or eliminating background signaling from an audio signal output from a speaker or headset. The present invention contemplates an ability to perform reliable and accurate signal cancellation so as to support voice recognition and other hands-free or voice dependent types of controls. The present invention particularly contemplates addressing difficulties in facilitating signal cancellation within environments where a background signal is intentionally introduced for one reason or another such that thereafter becomes desirable to remove that background signal from subsequent signal processing.

A police vehicle/cruiser may desire a hands-free microphone to enhance maneuver safety during radio communications and with high-end electronics to enhance voice-command recognition capabilities. A hands-free microphone may be ‘beam formed’ to direct sensitivity at the driver, but the vehicle siren forms a particular loud and persistent interference even into such directional microphones. The siren may interfere with an ability of a voice recognition processor or other device tasked with processing the corresponding microphone signal to accurately recognize voice commands issued by the police officer. Cancellation of the siren signal from the processed microphone signal may be beneficial to improving an ability of the voice recognition processor to accurately assess the voice command. Accordingly, there is a need for intelligent siren cancellation in the microphone audio processing path.

Traditional noise cancellation attempts to learn something about the characteristics of interference sources, either in direction or pattern, and supply calculated correction factors. A siren signal is always changing in frequency, and often in pickup intensity, and proves to be particularly difficult to find and remove. However, in the case of ‘siren’ interference the generated siren signal can be generated, and thus the fundamental frequency components can be assessed. For example, from a square-wave a siren-type signal generator creates, the fundamental frequency of siren components to be processed will be known, after accounting for the delay in amplifier electronics, the acoustic path, and the signal processing delay within the hands-free-microphone beam-forming.

### BRIEF DESCRIPTION OF THE DRAWINGS

FIG. 1 illustrates a police cruiser having a signal cancellation system in accordance with one non-limiting aspect of the present invention.

FIG. 2 illustrates a signal cancellation system as contemplated by one non-limiting aspect of the present invention.

FIG. 3 illustrates a microphone signal in accordance with one non-limiting aspect of the present invention.

FIG. 4 illustrates a siren signal in accordance with one non-limiting aspect of the present invention.

FIGS. 5-6 pictorially demonstrate addition of signal in accordance with one non-limiting aspect of the present invention.

FIG. 7 diagram illustrates a signal cancellation process in accordance with one non-limiting aspect of the present invention.

FIG. 8 illustrates a square wave in accordance with one non-limiting aspect of the present invention.

FIG. 9 illustrates a frequency-domain transfer function in accordance with one non-limiting aspect of the present invention.

FIG. 10 illustrates selecting signal portions to facilitate signal cancellation in accordance with one non-limiting aspect of the present invention.

FIG. 11 illustrates a flowchart of a method for signal cancellation as contemplated by one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

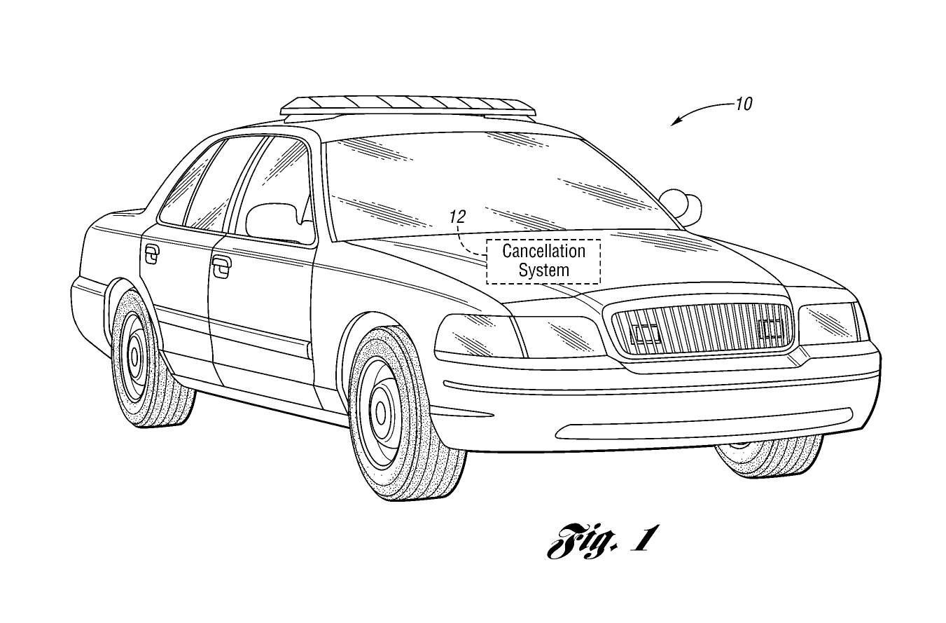

FIG. 1 illustrates a police cruiser 10 having a signal cancellation system 12 in accordance with one non-limiting aspect of the present invention. The police cruiser 10 is shown for exemplary purposes to demonstrate one use of the contemplated signal cancellation system 12. FIG. 2 illustrates the signal cancellation system 12 in accordance with one non-limiting aspect of the present invention. A siren signal 14 may be produced with a siren 16 included within the vehicle 10 to broadcast warning signals. A microphone signal 18 may be produced from a microphone 20 included within the vehicle 10 to communicate voice and other audio commands from an occupant to one or more vehicle systems (not shown), such as to facilitate hands-free or voice dependent control of various vehicle systems and subsystems. The signal cancellation system 12 contemplated by the present invention, however, is not necessarily limited to police vehicles or vehicles in general. The present invention fully contemplates its use and application in any environment where it may be desirable to facilitate signal cancellation, particularly when cancellation of intentionally generated signals is desired to prevent interference with signals being recorded or with signals being output.

The system 12 is shown and described for exemplary purposes to include a siren 16 comprised of a signal generator 24 and an amplifier/speaker 26, and a cancellation device 28. The signal generator 24 may be configured to output a signal 34 to the amplifier 26 for acoustic broadcast to an area surrounding the police cruiser 10. The hands-free microphone 20 may be a beam formed microphone or other microphone positioned within an interior of the vehicle 10 to receive and record, sample, or otherwise facilitate processing of ambient audio signals. The microphone 20 may be comprised of a single input or sampling device such that only a single ambient sampling is captured. While the present invention contemplates use of multiple microphones, the use of a single microphone or microphone signal to perform the desired signal cancellation is particularly contemplated as a means to facilitate hands-free communications and other signal processes without having to include additional expense of additional microphones. The microphone 20 and/or the signal cancellation system 12 may optionally lack the ability to simultaneously sample or process multiple ambient signals within the vehicle 10, i.e., the system 12 may be unable to use a cross-cancellation process or other comparative cancellation that require separate microphones within the vehicle.

The cancellation device 28 may be a digital signal processor (DSP) or other device having capabilities sufficient to facilitate the signal cancellation operations contemplated by the present invention. The cancellation device 28 is shown to include inputs for receiving signals from the signal generator 24 (e.g., siren signal 34) and the microphone 20 (e.g., microphone signal 18) and an output for communication of an output signal 36 (e.g., canceled signal) to a vehicle system, electronic control module, or other feature included within the vehicle 10 that may have the capabilities to process acoustic signaling in order to facilitate related vehicle control. The cancellation device 28 is shown to be configured to facilitate output of a filtered or canceled signal 36 such that any device receiving the output may be required to perform its own processing to uncover data carried within the signal. The cancellation device 28, however, may be configured to perform voice recognition or any other operation suitable to facilitating hands-free controller and/or to facilitate executing other operations based on the recorded verbal commands. The cancellation device 28 may be particularly beneficial in facilitating operations described within U.S. patent application Ser. No. 12/861,122, entitled “Handheld Controller Device”, the disclosure of which is hereby incorporated by reference in its entirety.

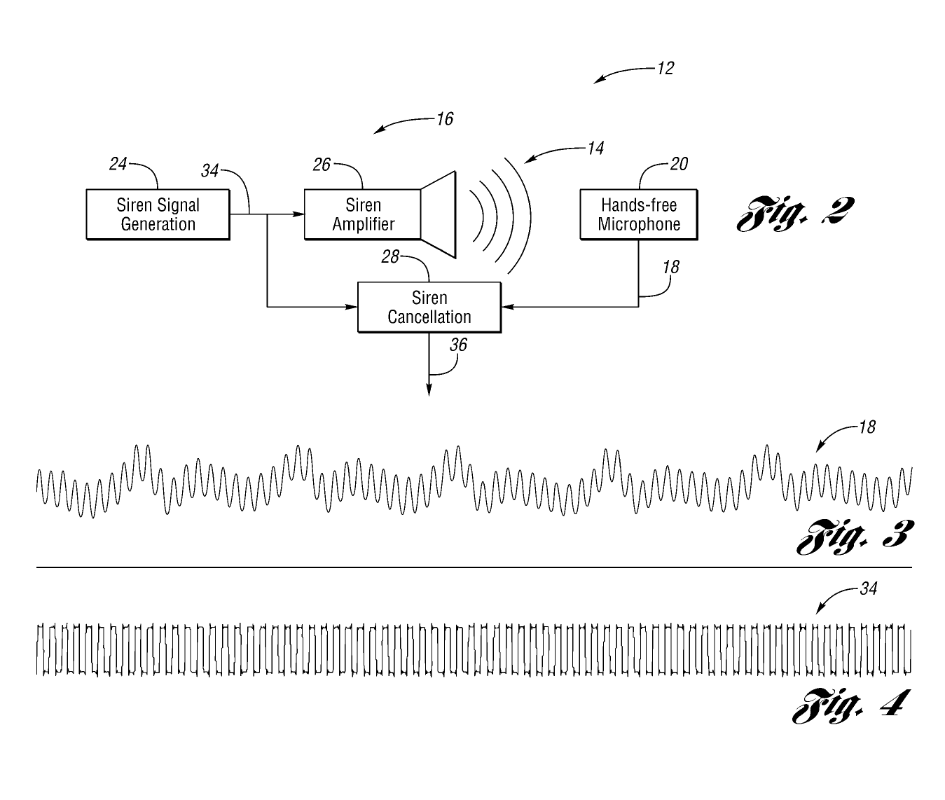

FIG. 3 illustrates the microphone signal 18 recorded with the microphone in accordance with one non-limiting aspect of the present invention. FIG. 4 illustrates the siren signal 34 as output from the signal generator in accordance with one non-limiting aspect of the present invention. The siren signal 34 is shown prior to being broadcasted with the amplifier 26, i.e., prior to being exposed to and/or interfering with the microphone signal 18. While the siren signal 34 is shown to be sampled as output from the generator 24, the present invention fully contemplates sampling the siren signal 34 after being output from the amplifier/speaker 26. Sampling of the siren signal 34 between the signal generator 24 and the amplifier/speaker 26 may be beneficial in eliminating noise or other interferences attributed to the siren signal 34 when performing the signal cancellation. This sampling of the signal 34 sampled prior to output may be beneficial because it is more accurate representation of the true siren signal 34 than if the siren signal cancellation were based on signals sampled or derived after being output from the amplifier/speaker 26.

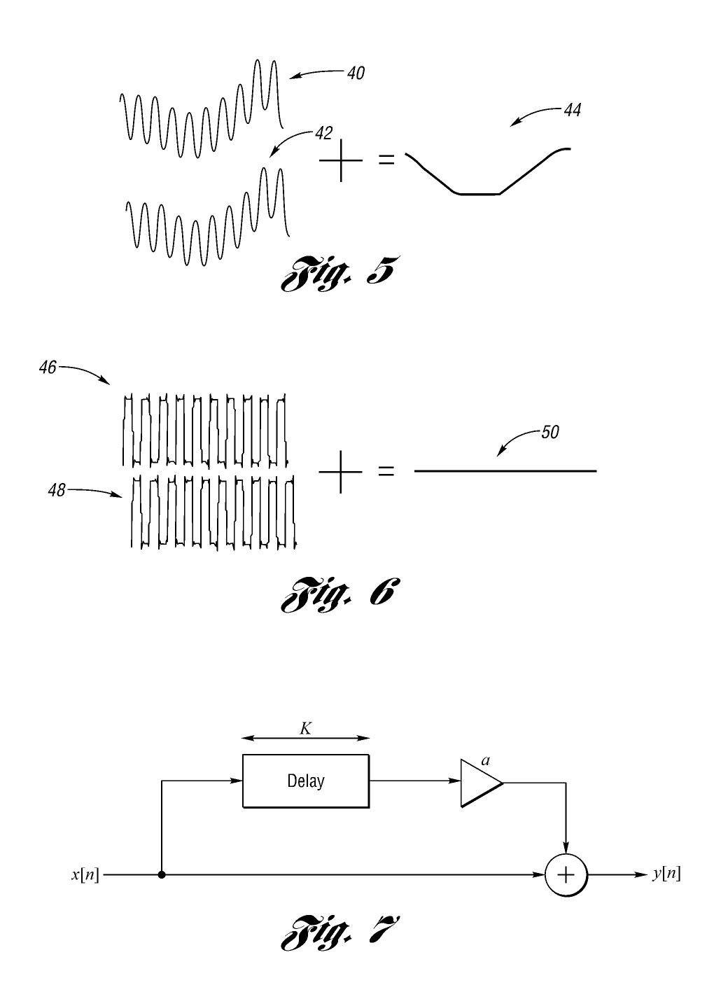

The cancellation device 28 may be configured to add portions of the microphone signal 18 to itself in order to cancel out the influence of the sounds produced by the siren 34. In particular, one non-limiting aspect of the present invention contemplates identifying a characteristic or representative frequency, such as but not necessary limited to a fundamental frequency, of the siren signal 34 and then using this frequency to identify a portion of the microphone signal 18 to be added to itself in order to cancel out the influence of the siren 16. FIG. 5 pictorially demonstrates addition of a first time-varying signal 40 to an offset copy 42 of itself to illustrate the contemplated signal cancellation 44 that may be performed on a similarly shaped microphone signal 18. FIG. 6 pictorially demonstrates addition of a second, square-wave signal 46 to an offset copy 48 of itself to illustrate the contemplated signal cancellation 50 that may be performed on a similarly shaped siren signal 34. As shown, the results 44, 50 of the corresponding addition operations illustrate output signals having certain portions of the signal canceled.

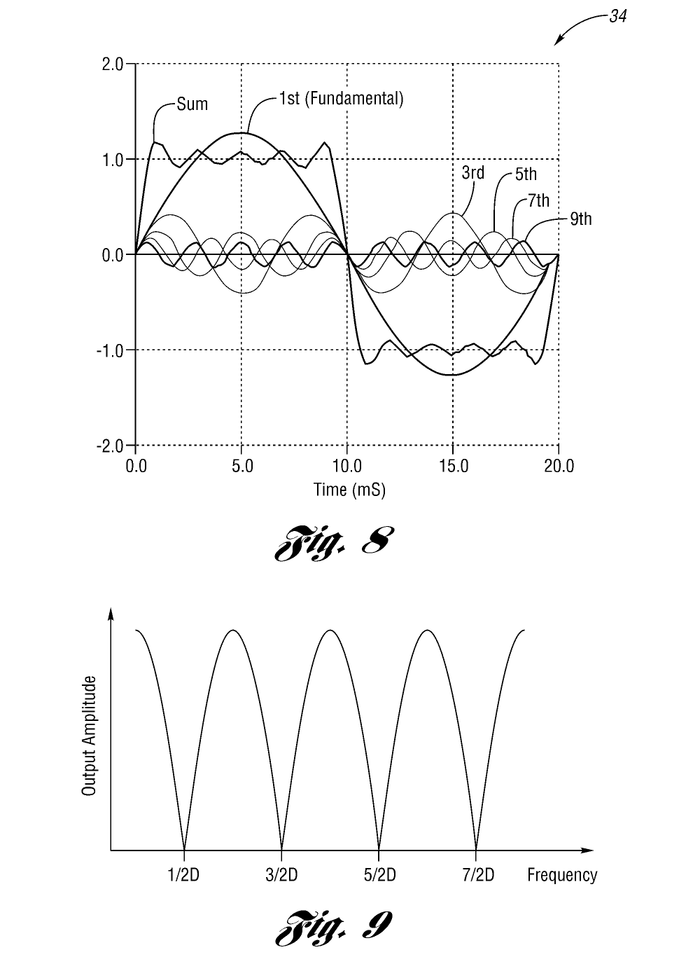

The present invention contemplates controlling the portions being canceled by controlling an amount by which the two signals being added are offset from each other. FIG. 7 diagrammatically illustrates the signal cancellation process where an input signal is added to itself to produce a canceled output signal. The process includes determining an amount of delay (K) and an of gain (α) in order to ensure that the signals offset by an amount calculated to cancel the desired signal. FIG. 8 illustrates a square wave representative of the siren signal 34 that may be output by the siren signal generator 24. The square wave illustrates a sum of the odd harmonics, a fundamental frequency or first harmonic, a third odd harmonic, a fifth odd harmonic, a seventh odd harmonic, and a ninth odd harmonic. For the illustrated 20 ms, the square wave is shown to demonstrate how the mirror halves are divided at the 10 ms interval. If the signals corresponding with 0-10 ms were added to the signals corresponding with 10-20 ms, each of the harmonics would essentially cancel its mirrored harmonic portion of the signal, thereby effectively canceling those (and by extension all odd) harmonics from the signal.

As illustrated in FIG. 8, the right-hand half of all these waveforms (10 to 20 ms in this example) is the exact inverse of the first half (0 to 10 ms). So where the reference siren-square-wave is sent thru an amplifier, speaker, and thru to a microphone system, those processes can add distortion, they won't change the frequencies as from the source waveform. So, if the square-wave frequency is known, all the odd harmonics related thereto can be canceled by adding the received waveform to itself one-half-period later (10 ms for this example 50 Hz)—this process is tantamount to a feedforward Comb filter, where in our case the feedforward gain α is 1 for complete cancellation. Using the previous example waveform, now with each waveform also shown with itself copied ½ period ‘later’, the sum of each copy will cancel the siren square wave, and by the same frequency components the same cancellation within the desired waveform.

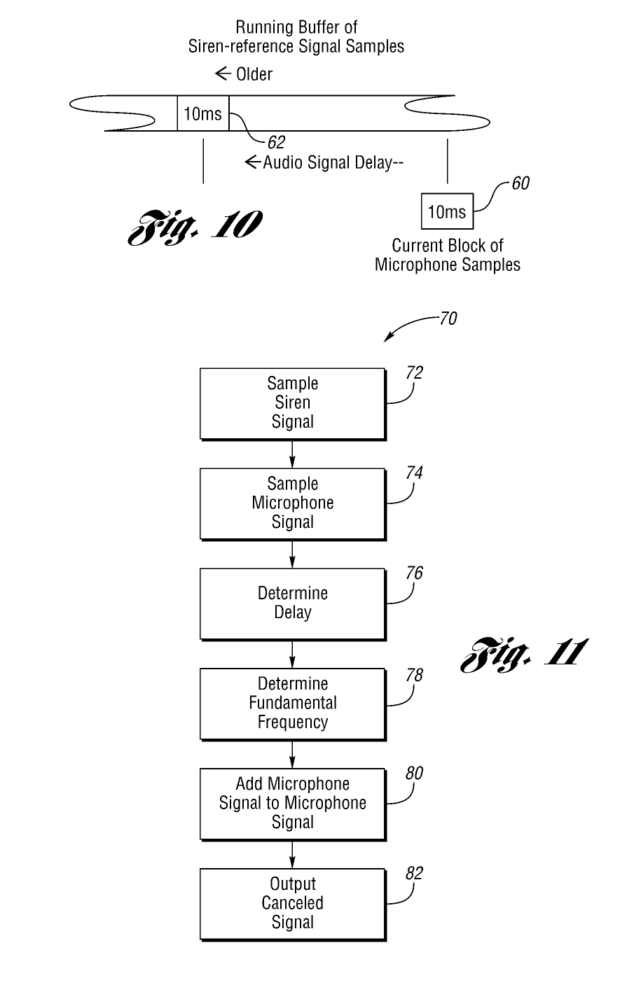

FIG. 9 illustrates a frequency-domain transfer function for a comb filter, for a base frequency with a period of 2D[delay] in accordance with one non-limiting aspect of the present invention. As shown, the reject notches are very deep, and can reject all these harmonics whatever their energy level, provided the correct base frequency is known. In the case of a siren signal source contemplated by the present invention, the frequency may be constantly changing as the siren ‘woops’ and ‘wails’. This is where the delay between the signal-generation source (e.g., siren signal) and the microphone input waveform (e.g., microphone signal) becomes important—the microphone waveform sampled at one point in time corresponds to the siren-reference from ‘some time ago’, that being the sum of the siren amplifier delay (thru device 26), acoustic delay in the major path from siren to microphone (path 14), and any delay in the microphone and its sampling process (thru device 26). So, to make this ‘tracking comb filter’ work, a running buffer of siren-reference samples may be kept in order to look ‘backwards’ into that buffer by this total delay factor and use the siren-reference frequency recorded there as the calculated waveform period, i.e. use ½ that period as the delay K in FIG. 7 to do the feedforward comb-filter operation.

FIG. 10 illustrates selecting the microphone signal 42 occurring at a current period of time and adding it to the microphone signal 40 occurring ‘K time ago’ in order to facilitate signal cancellation (yielding desired audio signal 44) in accordance with one non-limiting aspect of the present invention. More specifically, a DSP signal processing algorithm may work on discrete-samples of waveforms, e.g., in ‘blocks’ of those samples. So, for example, the present invention contemplates sampling at 16,000 samples per second, and working with 10 ms blocks of those samples at a time, or 160 samples per block. This is shown as block 60 in FIG. 10. If the overall ‘Audio Signal Delay’ 64 (the sum of delays 26, 14 and 26 mentioned previously) from siren-reference to microphone-samples is, 100 ms (value will vary depending on characteristics of system associated with the microphone and siren or other interfering noise), then a FIFO queue of at least the 1760 ‘most recent’ siren samples (a binary representation of the square wave being sufficient) to look ‘back into’ is needed. For this algorithm, a block of those samples 62, centered back at the delay 64, may be examined for siren-signal periods, and the periods found are averaged over the ms section (to match the signal-sample block size 60), and ½ that period is used as Delay ‘K’ in FIG. 7 to compute an output waveform 36 as the comb filtered result of the input microphone sample set.

Determining this ‘audio signal delay’ is thus critical to the success of this algorithm, given the narrow and deep filter characteristics of this comb-filter operation. How critical depends entirely on the ‘rate of change’ of the siren frequency. Assuming a desire to strive for 40 dB minimum siren cancellation, the frequency estimation must be accurate to within about 1%, or for a 2 KHz base frequency within about 20 Hz. If the siren ‘woop’ is making a 4 KHz/s sweep, then the maximum error in external delay estimation must be within 5 ms. For ‘fixed’ siren-to-mic installations, a single predetermined delay may be sufficient. For other installation scenarios, an active-feedback process looking at siren residuals for optimal delay time may be necessary. Also note that the discrete-sampling of the audio signals put discrete steps in the delay values, and if that proves inadequate for an application then specific re-sampling techniques need to be employed to effect ‘any-value’ delays.

FIG. 11 illustrates a flowchart 70 of a method for signal cancellation as contemplated by one non-limiting aspect of the present invention. The method may be embodied in a computer-readable medium having software or other instructions stored therein, which when executed with the processor other logically functioning element, may be configured to facilitate controlling the features shown above and/or other non-illustrated features necessary to perform the operations contemplated herein. The method is predominately described with respect to facilitating cancellation of the siren related signaling from microphone related signaling used within a police cruiser. This is done for exemplary non-limiting purposes as the present invention fully contemplates its use and application in facilitating signal cancellation in any type of environment.

The method is also described with respect to signal cancellation where at least one of the canceled signals is introduced with a generator or other device from which the fundamental frequency or other representation of the signal can be accurately determined, e.g., prior to being broadcasted or otherwise interfering with the signal from which it is being canceled. This particular use of the present invention is believed to be beneficial since it allows the canceled signal or a signal closely representative of the canceled signal to be determined prior to performing its interference, which is believed to provide a more accurate method by which cancellation can be performed. Of course, the present invention is not necessarily so limited and may be adapted or suitable for use in signal cancellation where the cancel signal is sampled after being introduced to the ambient environment of the sampling or output device and/or at some point after being broadcasted from the amplifier/speaker.

Block 72 relates to sampling the siren signal. The siren signal sampling may correspond with sampling or otherwise buffering the signal output from the signal generator to the amplifier/speaker, e.g., in real-time or with some more static recording. The signal may take the form of a square wave or other signal depending upon the particular siren selected for use and/or the type of signal producing the interference, e.g., a different signal may be used in the event a device other than the siren is producing interference, such as a signal representative of engine noise, horn, or other reproducible or consistent sound associated with the police cruiser. A buffer or other storage medium may be used to keep the sampled signal for a period of time sufficient to facilitate the contemplated signal cancellation.

Block 74 relates to sampling the microphone signal. The microphone signal sampling may correspond with sampling or otherwise buffering signals received with the microphone. The signal may correspond with some processing by the microphone or other feature associated with the microphone. The microphone signal may be representative of sounds within an interior of the vehicle or an area otherwise proximate to the microphone. The signals output by the siren may be sufficiently loud to interfere with or become exposed to the microphone such that the related siren sound is recorded by the microphone along with the other ambient sounds. A buffer or other storage medium may be used to keep the sampled signal for a period of time sufficient to facilitate the contemplated signal cancellation. Optionally, the microphone may be a beam-formed microform having a pickup directionality focused on a driver or other position within the vehicle so that some of the ambient influences outside of this directionality may be diminished, i.e., the microphone may be less receptive to sounds beyond a beam angle.

Block 76 relates to determining a delay period between the sampled siren signal and the sampled microphone signal. The delay period corresponds with a temporal difference between the output of the siren signal and the sampling of the microphone signal due to electronic and acoustical delays. The microphone sampling of a siren sounds may occur at some point in time after the siren signal is actually output due to various dilatory influences associated with the recording/sampling process of the microphone. In other words, the signals input to the cancellation device to represent the siren signal and the microphone signal are not necessarily in sequence with respect to the actual exposure of the siren sound to the microphone sounds. The actual sampled siren signaling being exposed to sampling with the microphone precedes the microphone signal input to the cancellation device. The corresponding temporal offset may vary according to the particular configuration of the police cruiser. A police cruiser of a first type may have a physical configuration or electrical/acoustical processing configuration which differs from a police cruiser of a second type such that the first type of vehicle may have more/less delay than the second type of vehicle.

Block 78 relates to determining the relevant delay period according to the particular configuration of the police cruiser or other factors associated with the environment or configuration of the signal cancellation system. The delay period may be empirically determined by an installer or technician performing a tuning operation of otherwise adjusting a delay period input to the cancellation device while listening to the canceled signal output. The installer can increase and decrease the determine delay period until producing the best audible result or accuracy, e.g. to the delay period that sounds the best. The delay period may also be determined automatically according to pre-programming or other programming of the cancellation device. This may, for example, include the cancellation device monitoring various vehicle systems or other input parameters and determining an appropriate delay period, e.g., test signals may be generated and sampled/process to determine the most desirable delay. The automatic delay period may also be determined according to positioning of the microphone or other components associated with processing the microphone signaling, e.g., an identifier of the microphone or microphone related processors may be input to look-up characteristics of the particular configuration.

Block 80 relates to determining a characteristic frequency of the siren signal. The siren signal shown to be analyzed prior to being output from the amplifier/speaker for exemplary purposes and may be sampled elsewhere. The characteristic frequency may be a fundamental frequency of the siren signal. The fundamental frequency may be desirable in order to identify each harmonic of the siren signal so that those harmonics can be removed from the microphone signal. The fundamental frequency may be determined by identifying and averaging edges of the siren signal occurring over a sampled period of time. The signal generator, for example, may output a square-wave which can be analyzed with the cancellation device or other feature for its edges and correspondingly average to determine the fundamental frequency over a certain period of time. The siren may vary and frequency over time and/or the police cruiser may include multiple sirens such that the fundamental frequency may need to be repeatedly determined or analyzed in order to ensure accuracy for the frequency-varying siren or the currently active siren. While a dynamic determination of the fundamental frequency is noted, the present invention fully contemplates being preprogrammed with the fundamental frequency for each siren, e.g., the fundamental frequency may be determined automatically from the selected siren and/or the current timestamp/duration of active siren.

Blocks 80, 82 relate to adding the microphone signal to itself in order to cancel out the influence of the siren signal and the corresponding output of the canceled signal for further use and controlling the vehicle or performing other desirable operations. The microphone signal may be added to itself by adding the microphone signal sampled at a first interval to the microphone signal sampled at a second interval. The second interval may be offset in time from the first interval by one-half of an inverse or period of the fundamental frequency.

The present invention is described above with respect to use with a police cruiser. The present invention, however, is not necessarily so limited and fully contemplated use and application in any number of environments. A home security system may be similarly susceptible to signal cancellation in the event a microphone or other voice sampling device is being used to communicate information regarding a hazard while the home security system is simultaneously playing an alarm or other loud warning signal. The signal cancellation contemplated by the present invention may be particularly beneficial with home security systems where microphones may be used to communicate messages from the home to a secured entity while signal generators within the home or providing signals that may interfere with an ability of the microphone to communicate to the secure entity. The signal cancellation may also be equally beneficial with applications, computers, phones or other devices where intentionally introduced noise or other signal generated sounds are produced in the background or in conditions around a microphone while a user is attempting to perform voice or other acoustic dependent operations.

The signal cancellation contemplated by the present invention involves adding one signal to itself or to a portion of the same input signal sampled at a later period of time. This configuration may be particular beneficial with periodic signals or other repeating signals having cycles which, at least over a short interval of time, repeat such that the addition of the signal to a preceding or succeeding portion causes certain harmonics to cancel out. The signal cancellation disclosed herein may result in some distortion or minor changes to the occupant voices or other recorded sounds, however, is believed that these distortions will be insignificant to the human ear and/or outweighed by the improved performance associated with eliminating or substantially reducing the influence of the siren sound. The signal cancellation may have a limited effect on the occupant voices or other non-periodic signals recorded with the microphone since the addition of the signals to itself may not provide the elimination cancellation associated with adding the periodic signals to themselves.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for canceling a siren signal from a microphone signal, the siren signal being output from a siren included within a vehicle, the microphone signal being generated with a microphone included within the vehicle, the method comprising:
determining a fundamental frequency of the siren signal;
sampling the microphone signal;
canceling the siren signal from the microphone signal, including adding the microphone signal sampled at a first interval to the microphone signal sampled at a second interval, the second interval being offset in time from the first interval by one-half of an inverse of the fundamental frequency.

2. The method of claim 1 further comprising determining the fundamental frequency of the siren signal from a first portion of the siren signal occurring proximate in time to the first interval.

3. The method of claim 2 further comprising retrieving the first portion from a buffer configured to record the siren signal.

4. The method of claim 3 further comprising determining the first portion to be offset in time from the first interval by a delay period.

5. The method of claim 4 further comprising determining the delay period to be a first amount if the vehicle is a first type of vehicle and a second amount if the vehicle is a second type of vehicle, the first amount being less than the second amount.

6. The method of claim 4 further comprising determining the delay period to correspond with a total electronic and acoustic delay associated with providing the microphone signal to a siren cancellation device, the siren cancellation device adding the microphone signal sampled at the first interval to the microphone signal sampled at the second interval.

7. The method of claim 1 further comprising determining the fundamental frequency from a square-wave of a siren signal generator emitted to the siren for output as the siren signal.

8. The method of claim 7 further comprising determining the fundamental frequency when a frequency of the siren signals varies over time.

9. The method of claim 1 further comprising determining the fundamental frequency of the siren signal from a portion of the siren signal sampled prior to being output from the siren.

10. The method of claim 1 further comprising determining the fundamental frequency of the siren signal from a portion of the siren signal sampled after being output from the siren.

11. The method of claim 1 further comprising the first interval preceding the second interval.

12. The method of claim 1 further comprising the first interval succeeding the second interval.

13. A method of filtering an interference signal from a microphone signal, the microphone signal being recorded with a microphone exposed to the interference signal, the interference signal being intentionally produced with a signal generator, the method comprising:
adding an a first portion of the microphone signal to a second portion of the microphone signal, the second portion occurring in time after the first interval by an amount of time proportional to a fundamental frequency of the interference signal.

14. The method of claim 13 further comprising determining the amount of time to be one-half a period of the fundamental frequency.

15. The method of claim 13 further comprising determining the fundamental frequency from a selected portion of the interference signal recorded prior to the first portion of the microphone signal.

16. The method of claim 15 further comprising determining an amount in time by which the selected portion occurs before the first portion to be proportional to a delay associated with the microphone processing the microphone signal.

17. The method of claim 13 further comprising determining the fundamental frequency by sampling the interference signal after being output from the signal generator and prior to being exposed to the microphone.

18. An acoustics system comprising:
a signal generator configured to generate a first signal;
an amplifier configured to convert the first signal to a second signal, the second signal being acoustically broadcasted from the amplifier;
a microphone configured to facilitate sampling a third signal, the third signal representing sound ambient to the microphone, the microphone being exposed to the second signal such that the third signal at least partially represents the second signal; and
a cancellation device configured to output a fourth signal, the fourth signal representing with the third signal after cancellation of at least a portion of the second signal.

19. The system of claim 18 wherein the cancellation device is configured to generate the fourth signal by adding a first portion of the third signal to a subsequently occurring second portion of the third signal.

20. The system of claim 18 wherein the cancellation devices is configured to determine a fundamental frequency of the first signal and to add the second portion of the third signal occurring ½ of an inverse of the fundamental frequency after the first portion to the first portion.
